(19) United States
(12) Patent Application Publication
(10) Pub. No.: US 2007/0157770 A1
(43) Pub. Date: Jul. 12, 2007

(54) ADJUSTABLE WRENCH HAVING NUT-GRIPPING JAWS

(76) Inventor: Tomas Foltyn, Abbotsford (CA)

Correspondence Address: OYEN, WIGGS, GREEN & MUTALA LLP;480 - THE STATION, 601 WEST CORDOVA STREET, VANCOUVER, BC, V6B 1G1, US

(21) Appl. No.: 11/620,601

(22) Filed: Jan. 5, 2007

Related U.S. Application Data
(60) Provisional application No. 60/756,580, filed on Jan. 6, 2006.

(51) Int. Cl. B25B 13/16

(52) U.S. Cl. 81/165

(57) ABSTRACT

An adjustable wrench comprising a handle, a fixed jaw non-movably attached to the handle and a movable jaw slidably attached to the handle. One of the fixed jaw and the movable jaw has a generally V-shaped recess. The other of the fixed jaw and the movable jaw has a protrusion aligned with a center line of the V-shaped recess.

### REFERENCE TO RELATED APPLICATION

This application claims priority from U.S. provisional patent application No. 60/756580, filed Jan. 6, 2006 and entitled “ADJUSTABLE WRENCH HAVING NUT-GRIPPING JAWS”, which is incorporated by reference herein.

### FIELD OF THE INVENTION

This invention relates to hand tools. Particular embodiments of the invention provide hand tools for turning fittings such as nuts, bolts and flare-fittings. The invention may be embodied, for example, in an adjustable wrench or a pair of slip-joint pliers.

### BACKGROUND

Adjustable wrenches are often used by tradespeople because a single adjustable wrench can fit a wide range of fasteners. Having an adjustable wrench can avoid the need to carry a set of fixed wrenches in some situations. By using an adjustable wrench one can avoid taking time to select an appropriately-sized fixed wrench. One can also avoid the need to change back and forth between different sizes of fixed wrenches when it becomes necessary to adjust fittings having different sizes.

One popular type of adjustable wrench has a fixed jaw. The fixed jaw has a flat face extending parallel to a matching flat face of a movable jaw. The distance between the fixed and movable jaws can be adjusted to accommodate fasteners having different sizes. One disadvantage of these adjustable wrenches is that they contact the fitting only on two opposing faces. If such a wrench is not perfectly adjusted or if the fitting is very tight then the jaws can slip. This can both damage the fastener and cause injury to the tradesperson if the slippage occurs suddenly.

Slip-joint pliers are another tool commonly used by tradespeople to turn fittings. Slip-joint pliers can be adjusted over a wide range of sizes. They have the disadvantage that they do not always tightly grip the head of a fastener or other fitting. Consequently they can cause the fitting to be damaged unless they are used very carefully.

The inventor has identified a need for hand tools that address some of the deficiencies of wrenches, pliers and similar tools that are currently available.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides an adjustable wrench comprising a handle, a fixed jaw non-movably attached to the handle and a movable jaw slidably attached to the handle. One of the fixed jaw and the movable jaw has a generally V-shaped recess defined therein on a side facing toward the other of the fixed jaw and the movable jaw. The other of the fixed jaw and the movable jaw has a protrusion thereon. The protrusion is aligned with a center line of the V-shaped recess.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an adjustable wrench according to one embodiment of the invention.

FIG. 2 shows the wrench of FIG. 1 gripping a fastener.

FIG. 3 shows the wrench of FIG. 1 gripping a fastener smaller than the fastener shown in FIG. 2.

FIG. 4 shows the wrench of FIG. 1 gripping a fastener between outer portions of its jaws.

FIG. 5 shows the wrench of FIG. 1 in an open configuration.

FIG. 6 shows an adjustable wrench according to an alternative embodiment of the invention having a handle that is curved toward an adjustable jaw of the wrench.

FIG. 7 shows a wrench according to an alternative embodiment to the invention having a handle curved toward a fixed jaw of the wrench.

FIG. 8 shows an adjustable wrench according to the invention having a pivotally mounted handle.

FIG. 9 shows a wrench according to an alternative embodiment to the invention having a ratchet assembly on a tail end of a handle of the adjustable wrench.

FIG. 10 shows a pair of slip-joint pliers according to an alternative embodiment of the invention.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

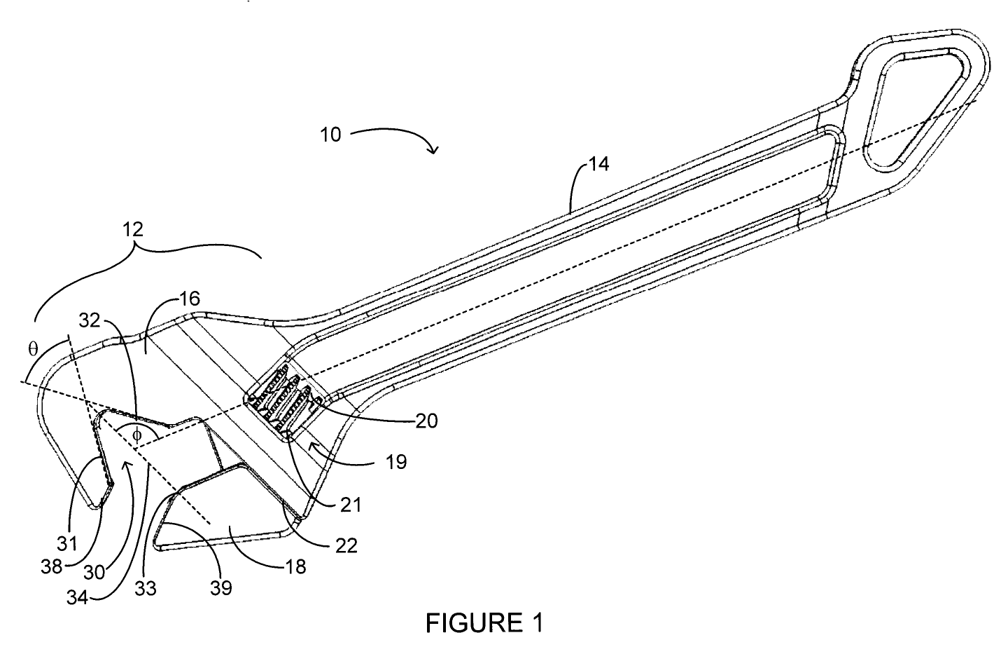

FIG. 1 shows an adjustable wrench according to a specific embodiment to the invention. Wrench 10 has a head 12 attached to a handle 14. Head 12 includes a fixed jaw 16 and a movable jaw 18. Movable jaw 18 can be moved toward or away from fixed jaw 16 by manipulating an adjustment mechanism 19. In the illustrated embodiment, adjustment mechanism 19 comprises a worm 20 that engages a rack 21 on the base of movable jaw 18. By rotating worm 20 relative to rack 21, movable jaw 18 can be made to slide back and forth along a linear track 22.

Fixed jaw 16 is characterized by a V-shaped recess 30 defined in its side facing toward movable jaw 18. Recess 30 has opposing sides 31 and 32 that are disposed at an angle θ to one another. Angle θ is typically in the range of 55-65° and is preferably approximately 60°.

Movable jaw 18 has a projection 33 that is aligned with a center line 34 of recess 30. Center line 34 is preferably parallel to track 22 so that as movable jaw 18 is moved back and forth projection 33 remains on the center line 34 of recess 30.

In the embodiment illustrated in FIG. 1, center line 34 of V-shaped indentation 30 makes an angle φ with the center line of handle 14. The particular angle φ may be selected to have any value in a wide range. In the illustrated embodiment φ is approximately 105 degrees. This gives wrench 10 an offset of 15 degrees. However, wrenches could readily be made for which the angle φ is anywhere in the range of 0-180°.

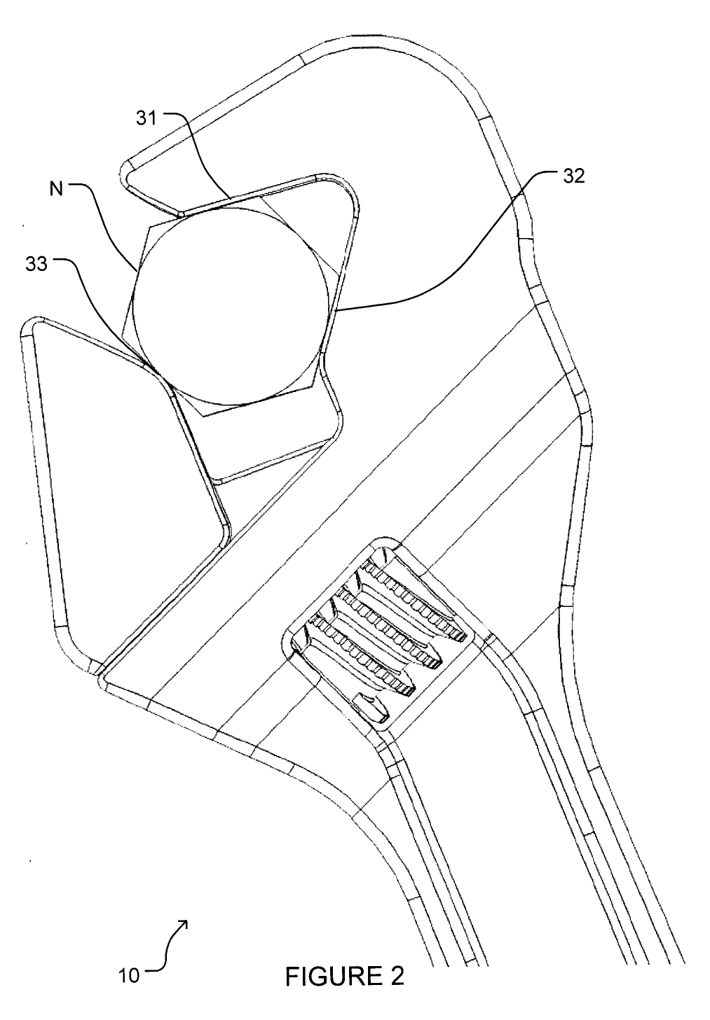

Wrench 10 may be used to grip hexagonal fittings in various ways. Two of these ways are shown in FIGS. 2 to 4. FIG. 2 shows wrench 10 gripping a hexagonal nut, N. The nut is received in recess 30 with two sides of the nut bearing against sides 31 and 32 of recess 30. A third side of the nut is in contact with projection 33. Nut N is therefore securely held between the jaws of wrench 10 and is prevented from rotating relative to the jaws of wrench 10 even if significant torque is applied to the nut by pulling hard on handle 14 of wrench 10. Wrench 10 engages every other face of nut N. Since nut N is hexagonal, the faces of nut N against which wrench 10 bears are at angles of 60 degrees to one another.

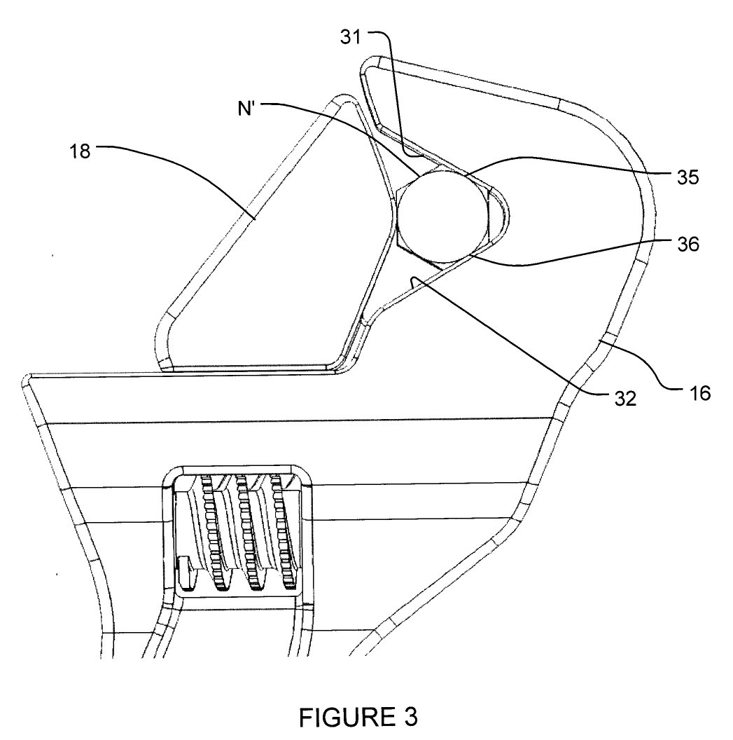

FIG. 3 shows wrench 10 gripping a nut N′ that is smaller than nut N of FIG. 2. Each of sides 35 and 36 of nut N′ are in full contact with sides 31 and 32 of fixed jaw 16 respectively.

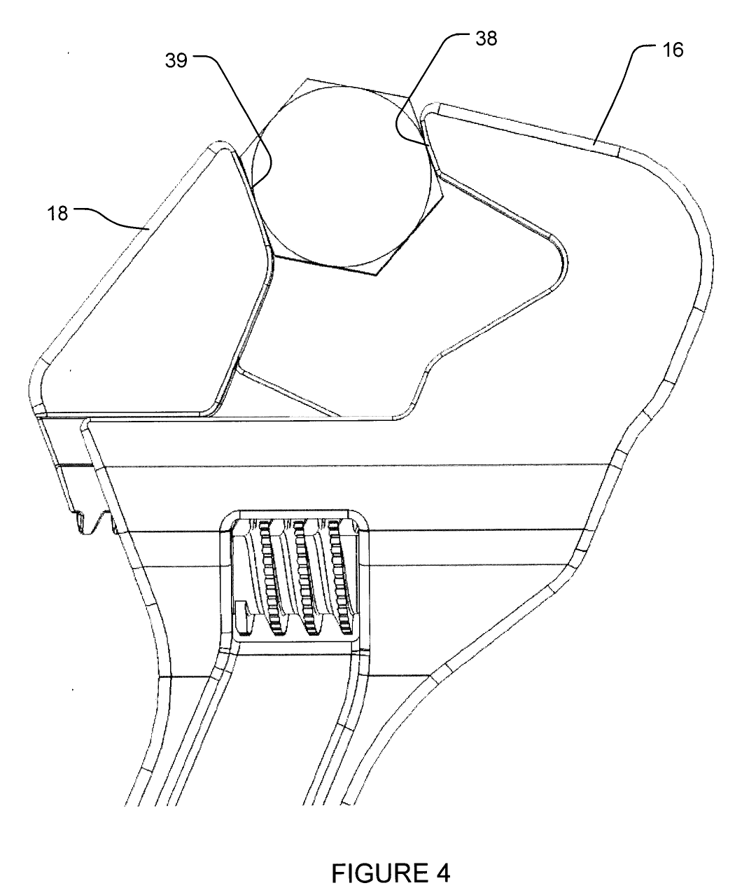

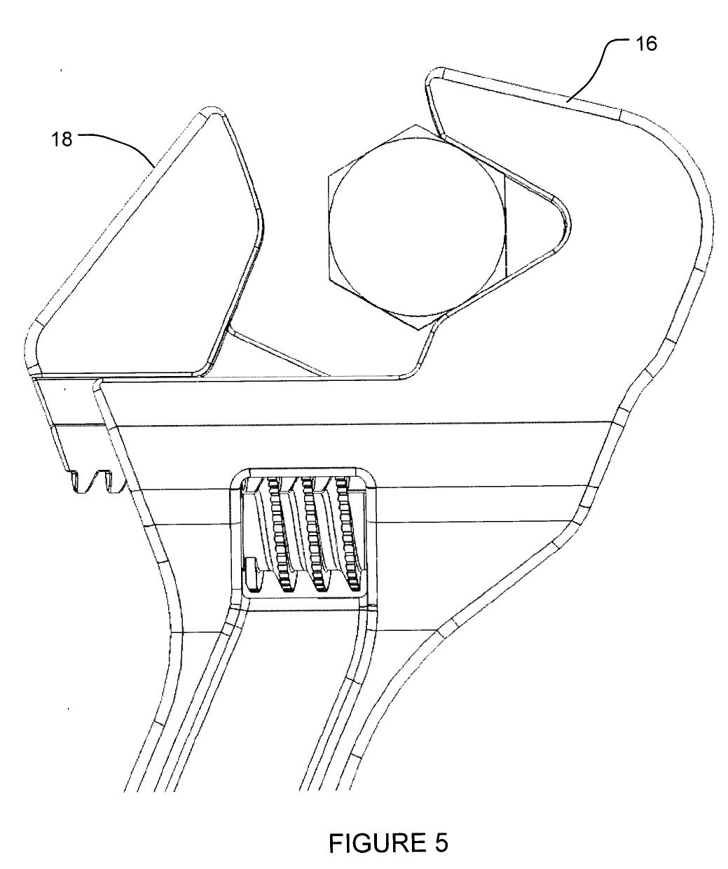

FIG. 4 shows an alternative way to hold a fastener using wrench 10. In the particular embodiment of wrench 10 illustrated in FIG. 4, fixed jaws 16 and 18 respectively have flattened outer portions 38 and 39. Portions 38 and 39 are parallel to one another. Therefore, opposing sides of a hexagonal or square object such as a nut can be gripped between faces 38 and 39, as shown in FIG. 4. A tradesperson could use this feature to turn fasteners or fittings which have already been loosened, or are in the early stages of being tightened, where large amounts of torque are not required. A user can set the gap between faces 38 and 39 to a known value, for example by gripping a spacer between faces 38 and 39, to obtain an initial setting for the spacing of movable jaw 18 from fixed jaw 16.

A wide range of modifications are possible in the design of wrench 10. For example, the precise nature of mechanism 19 that allows jaw 18 to be positioned relative to jaw 16 is not important. There are a wide range of such mechanisms known. Any suitable mechanism capable of sliding jaw 18 toward jaw 16 along track 22 until it is at a position suitable for holding a fastener or other fitting between movable jaw 18 and fixed jaw 16 may be used.

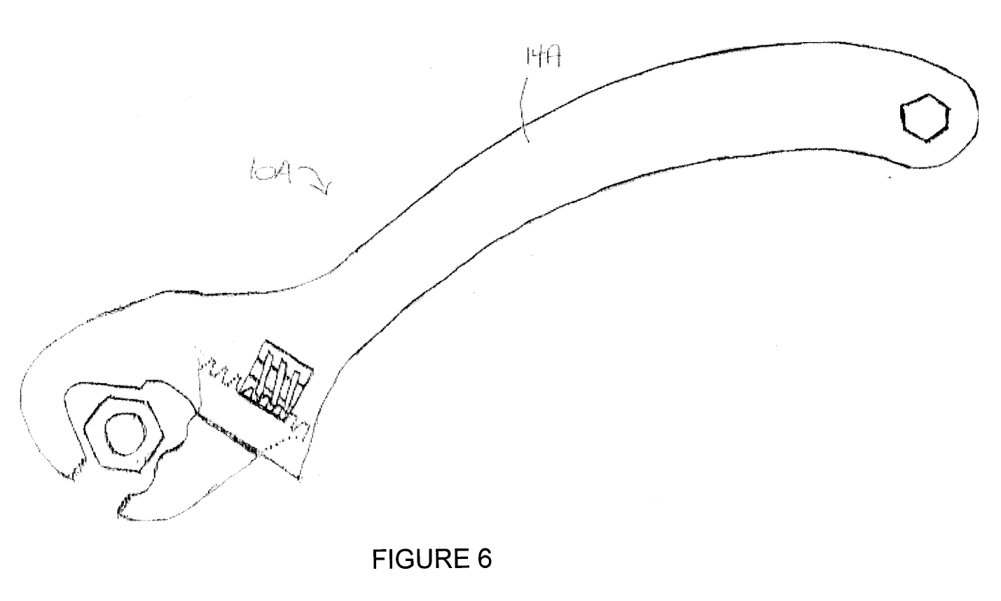

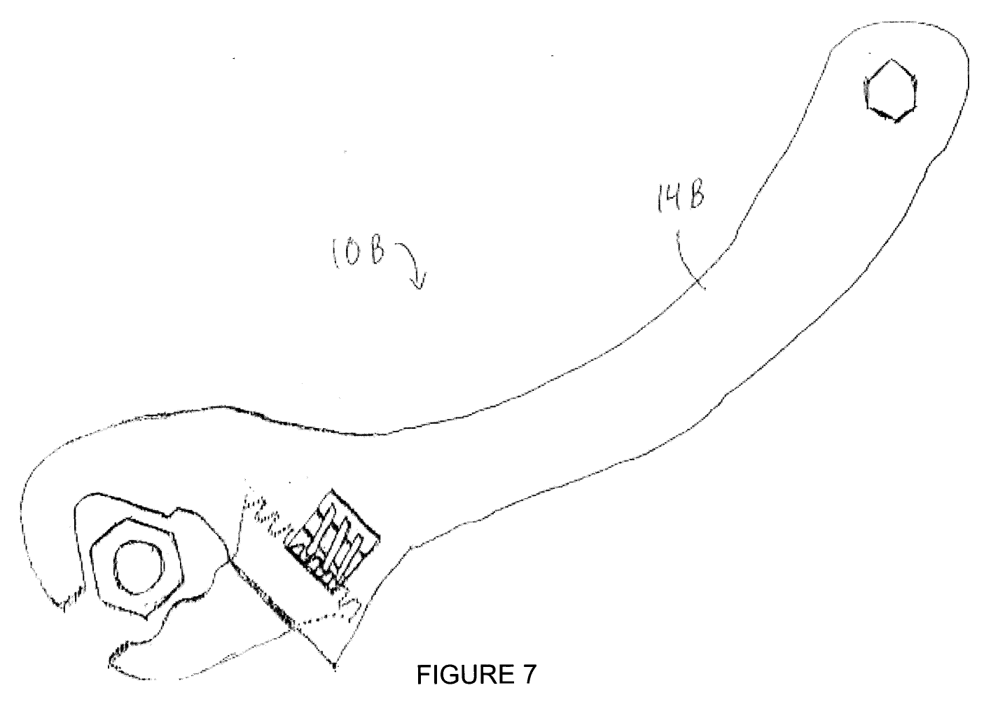

Handle 14 may be any handle suitable to allow a user to turn head 12. Handle 14 may be straight, as shown in FIG. 1, or may have another shape, such as being curved. FIG. 6 shows a wrench 10A having a handle 14A that is curved in a direction away from fixed jaw 16. In the alternative, handle 14 could be curved in a direction away from movable jaw 18, as shown in FIG. 7. FIG. 7 shows a wrench 10B having a handle 14B that is curved away from movable jaw 18.

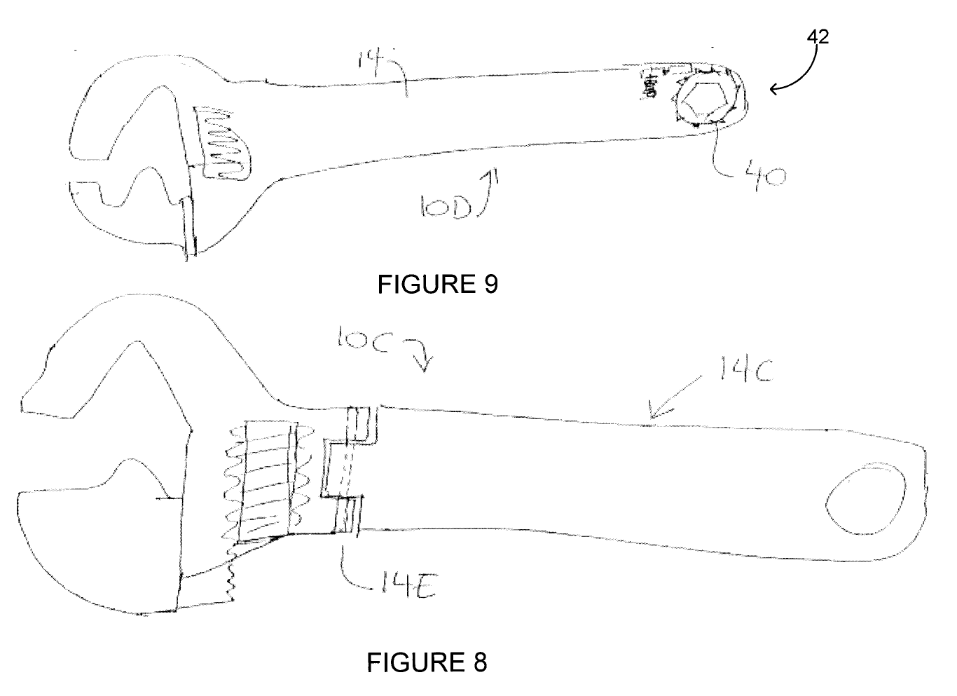

FIG. 8 shows a wrench 10C having another handle configuration. In FIG. 8, handle 14C comprises a rigid handle portion 14D which is pivotally connected to head 12 at a pivot joint 14E. Pivot joint 14E permits handle 14C to be pivoted out of the plane of head 12. This can be useful in some situations. In other embodiments (not shown) handle 14 could be bent to provide an offset or to cause handle 14 to extend at an angle to the plane of head 12.

Handle 14 may be any suitable length, depending upon the intended use of wrench 10. Handle 14 would typically have a length in the range of 6″ to 36″. A prototype wrench as shown in FIG. 1 has a length of approximately 10″.

The jaw configuration shown in FIG. 1 is not limited to cases where V-shaped recess 30 is defined in a fixed jaw, although there are advantages to providing recess 30 in the fixed jaw. It is also possible to provide recess 30 in a movable jaw and to provide projection 33 on the fixed jaw. This alternative construction could cause additional strain on the movable jaw and is therefore not preferred in most cases.

Instead of providing one fixed jaw and one movable jaw, a wrench according to the invention could have two jaws that are each movable relative to a handle 14 so that the two jaws can be moved toward or away from one another. A single mechanism may be provided for adjusting the positions of both jaws or, in the alternative, separate mechanisms may be provided for adjusting the position of both movable jaws. Once again, any suitable mechanisms may be used including any of the wide range of mechanisms that have been disclosed in the art and to which those who have read this disclosure would understand could be used in the context being discussed herein.

Optionally, as shown in FIG. 9, another wrench or accessory may be provided at a tail end of handle 14. FIG. 9 shows a wrench 10D according to the invention having a ratchet mechanism 40 at a tail end 42 of handle 14.

The thickness of jaws 16 and 18 may be selected for the intended application. For heavy duty applications jaws 16 and 18 may be made thicker, whereas for applications in which fittings need to be gripped in close quarters jaws 16 and 18 may be made thinner.

A wrench like wrench 10 may have any suitable surface finish. Handle 14 may be covered with rubber or a suitable plastic to provide a comfortable grip, if desired.

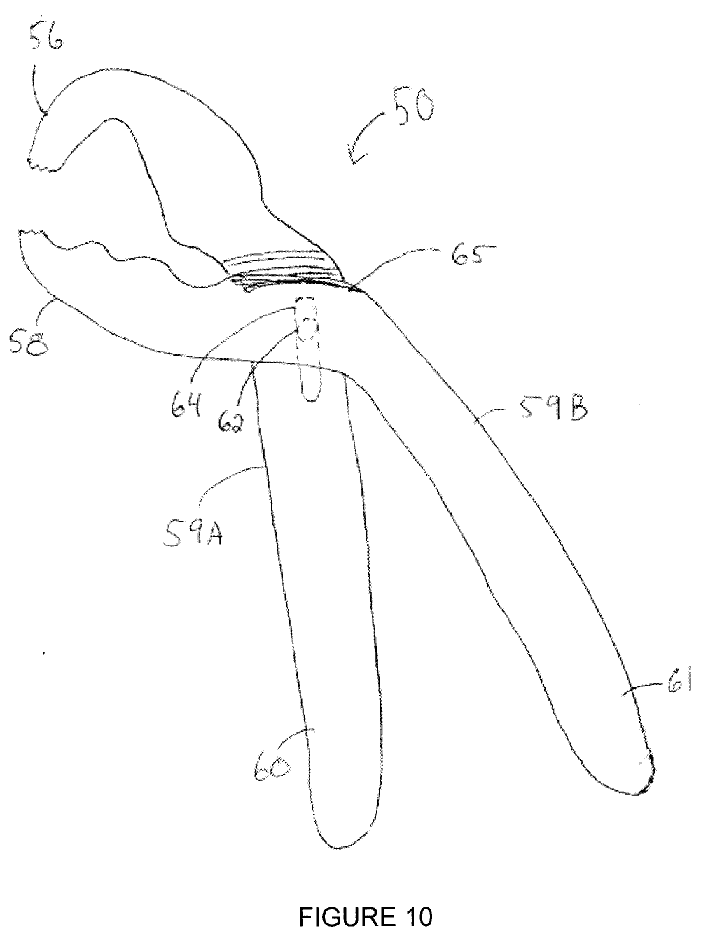

FIG. 10 shows a tool 50 according to an alternative embodiment of the invention. Tool 50 is in the form of a pair of slip-joint pliers. Tool 50 has a pair of jaws 56 and 58 which have a configuration like jaws 16 and 18 of wrench 10. Jaw 56 is connected to a handle 60. Jaw 58 is connected to a handle 61. Handles 60 and 61 are pivotally connected to one another by a pivot pin 62 which passes through a slot 64 on the part 59A that includes jaw 56 and handle 60. The part 59B that includes jaw 58 and handle 61 has an arcuate ridge 65 that is centered on pivot pin 62. Ridge 65 can engage one of a plurality of corresponding arcuate grooves in part 59A. Apart from jaws 56 and 58, tool 50 may have the form of a standard pair of slip-joint pliers. Such pliers are well understood to those skilled in the art of designing and making and using tools and therefore will not be described further herein.

Any of the tools described above may be made with jaws that are made of or faced with a non-marring material for use in turning fittings that are polished or have other ornamental surface treatments. Optionally a tool as described above may have jaw covers of a non-marring material, such as a suitable plastic, leather, a soft metal, or the like. The jaw covers may be slipped over the jaws to cover at least portions of the jaws that contact a fitting when the jaws engage the fitting.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An adjustable wrench comprising a handle, a fixed jaw non-movably attached to the handle and a movable jaw slidably attached to the handle to allow linear movement of the movable jaw toward and away from the fixed jaw, one of the fixed jaw and the movable jaw having a generally V-shaped recess defined therein on a side facing toward the other of the fixed jaw and the movable jaw, and the other of the fixed jaw and the movable jaw having a protrusion thereon, the protrusion aligned with a center line of the V-shaped recess.

2. An adjustable wrench according to claim 1 wherein the V-shaped recess is defined in the fixed jaw and the protrusion is on the movable jaw.

3. An adjustable wrench according to claim 1 wherein the V-shaped recess is on the movable jaw and the protrusion is on the fixed jaw.

4. An adjustable wrench according to claim 1 wherein the V-shaped recess has two opposed flat sides which define an angle in the range of 55 to 65 degrees.

5. An adjustable wrench according to claim 4 wherein the angle is approximately 60 degrees.

6. An adjustable wrench according to claim 1 wherein the movable jaw is slidable along an adjustment direction parallel to the center line of the V-shaped recess.

7. An adjustable wrench according to claim 1 wherein the fixed jaw and the movable jaw each comprise a flattened outer portion, the flattened outer portions oriented parallel to one another.

8. An adjustable wrench according to claim 1 wherein the handle is generally straight.

9. An adjustable wrench according to claim 1 wherein the handle is curved in a direction toward the fixed jaw.

10. An adjustable wrench according to claim 1 wherein the handle is curved in a direction away from the fixed jaw.

11. An adjustable wrench according to claim 1 wherein the handle comprises a rigid portion connected to the jaws by a pivot joint such that the rigid portion may be pivoted out of a plane of the jaws.

12. An adjustable wrench according to claim 1 wherein the handle is bent to provide an offset.

13. An adjustable wrench according to claim 1 wherein the handle is bent to extend at an angle to a plane of the jaws.

14. An adjustable wrench according to claim 1 comprising an accessory at a tail end of the handle opposite the jaws.

15. An adjustable wrench according to claim 14 wherein the accessory comprises a ratchet mechanism.

16. An adjustable wrench comprising a handle and first and second jaws coupled to the handle, at least one of the first and second jaws slidable with respect to the handle along an adjustment direction, one of the first and second jaws having a recess, the recess having two opposed flat sides which define an angle therebetween, and the other of the first and second jaws having a protrusion, the protrusion aligned with a center line of the recess.

17. An adjustable wrench according to claim 16 wherein both of the first and second jaws are movable with respect to the handle along the adjustment direction.

18. An adjustable wrench according to claim 17 comprising a single adjustment mechanism for moving both of the first and second jaws with respect to the handle.

19. An adjustable wrench according to claim 17 comprising first and second adjustment mechanisms for respectively moving the first and second jaws with respect to the handle.

20. An adjustable wrench according to claim 16 wherein the first jaw is non-movably attached to the handle and the second jaw is slidably attached to the handle, the first jaw having the recess and the second jaw having the protrusion.
